(19) United States
(12) Patent Application Publication
(10) Pub. No.: US 2025/0166524 A1
(43) Pub. Date: May 22, 2025

(54) TEACHING DEVICE FOR ELECTRONIC PIANO

(71) Applicant: PIANO LED, Verdun (FR)

(72) Inventors: Anthony Bitar, Verdun (FR); Gauthier Mayer, Belleville-sur-Meuse (FR)

(21) Appl. No.: 18/840,393

(22) PCT Filed: Mar. 1, 2023
(86) PCT No.: PCT/FR2023/000019

§ 371 Date: Aug. 21, 2024

(30) Foreign Application Priority Data
Mar. 1, 2022 (FR) FR2201802

(51) Int. Cl. G09B 15/08

(52) U.S. Cl. CPC G09B 15/08

(57) ABSTRACT

The invention relates to a teaching device (1) for electronic piano. The teaching device (1) comprises a processing unit (2) and a light-emitting strip (3). The processing unit (2) comprises a casing (11′) housing an electronic control module (12) configured to be driven by a remote peripheral terminal. The light-emitting strip (3) is flexible and is removably connected to the processing unit (2) by cabling (6), the light-emitting strip (3) being configured to visually guide to at least one note to be played when said light-emitting strip (3) is mounted on a keyboard of the electronic piano.

The technical context of the present invention relates to support for teaching music, in particular to support devices for teaching the piano, and more specifically electronic piano. More specifically, the invention relates to a teaching device for electronic piano.

Playing the piano requires long learning times. To have a student make progress, a traditional teaching method is to follow courses with a teacher. In addition to these courses, the student has to train regularly and repetitively. Thanks to these repetitive exercises, the student may gain some dexterity. They learn how to play only a piece of music by playing a succession of expected notes. A student is often alone to train with these exercises, in particular for financial reasons. Training alone can be difficult, tiring and demoralizing, in particular for novice students, while dedication and personal investment are keys to success for such practice.

In the state of the art, it is known teaching devices for the electronic piano, which are designed to help a user learn the piano. In particular, it is known devices for teaching the piano that guide a user with light signals specifying which key or chord to play and when to play it. These appliances complete, and sometimes replace the traditional teaching method with a teacher and allow the user to begin with music and make progress by an electronically guided and autonomous training.

Among these teaching appliances for electronic piano, there are electronic pianos integrating a light-emitting device in the keys of the keyboard. For example, the keyboards for beginners LK-S250 and LK-S450, commercialized by CASIO, are light-emitting keyboards. They each feature 61 light-emitting keys that can each turn on and off, each independently as a function of a given digital score. In these light-emitting keyboards, each lighted key singles out the one or several notes to be played to guide the user in learning the piano. Then, the user knows where to lay their fingers to play the score. Such a device makes it possible to autonomously learn notes in an intuitive and playful way.

The drawback of these keyboards is that the light-emitting device is constitutive of the keys. In other words, the light-emitting device is part of the keyboard: the light-emitting device and the keyboard cannot be separated from each other without affecting their integrity, since the light-emitting device and the keyboard are an inseparable set. Since it cannot be separated from the keyboard, the light-emitting device cannot be moved from an electronic piano when the user moves or changes of instrument. Such a keyboard is suitable for beginners. It becomes useless when the user masters the piano and, often, a new piano is bought as a replacement.

Furthermore, it is known teaching devices of the electronic piano external to the keyboard and designed to alternatively cooperate with several electronic pianos. These removable teaching devices can be mounted on electronic pianos that, by default, do not feature teaching functions, such as light-emitting keyboards. These removable teaching devices offer a movable alternative to light-emitting keyboards and make it possible to transform at will a classical electronic piano into a teaching piano.

Among these teaching appliances for electronic piano, there is the system described in the patent document U.S. Pat. No. 6,407,324B1. The system described in the patent document U.S. Pat. No. 6,407,324B1 relates to a teaching device for the piano, which comprises a framework that can be positioned on the keyboard of a piano, lying on the black keys, and two rows of lighting means, each with a plurality of LEDs. These two rows are located along the framework and are designed to lie over each note. Red LEDs are located on the lower row that aim at guiding the play of the left hand and green LEDs are located on the upper row that aim at guiding the play of the right hand. When a play, which was encrypted in a computer chip of the device, is selected, the notes to be played light up red or green according to the hand that shall play that note at that moment.

A drawback of this teaching device is the volume of such an appliance. Indeed, the framework comprising the LEDs constitute a bar that is designed to extend along a wide part of the keyboard of the piano. Although removable, such a framework is cumbersome, impractical to move and to store when it is not used.

The purpose of the present invention is to set forth a new teaching device for electronic piano, in order to cope at least partially with the issues above and to provide new advantages in addition.

Another purpose of the invention is to set forth a teaching device for electronic piano that is space-saving, which guarantees the compacity and the lightness of said teaching device.

Another purpose of the invention is to set forth a teaching device for electronic piano that is removable from the electronic piano that it is designed to be mounted on.

Another purpose of the invention is to set forth a teaching device for electronic piano, whose mounting on the electronic piano is made easier.

Another purpose of the invention is to set forth a teaching device for electronic piano, whose disassembly is made easier.

Another purpose of the invention is to set forth a simple teaching device for electronic piano, both in terms of implementation as of manufacture.

Another purpose of the invention is to set forth a teaching device for electronic piano that is configured to restrict the number of required operations for its mounting, in order to optimize the time of production of said teaching device.

Another purpose of the invention is to set forth a teaching device for electronic piano that is universal and configured to adapt to various types of electronic pianos.

According to a first aspect of the invention, at least one of the purposes above is reached by a teaching device for electronic piano, the teaching device comprising:
(i) a processing unit comprising a casing housing an electronic control module configured to be driven by a remote peripheral terminal;
(ii) a light-emitting strip being configured to visually guide to at least one note to be played when said light-emitting strip is mounted on a keyboard of the electronic piano, characterized in that the light-emitting strip is flexible and is removably connected to the processing unit by cabling.

The invention is designed to help a user learn the electronic piano. The learning device according to the first aspect of the invention constitutes a movable teaching device for electronic piano. The teaching device according to the invention is, as such, independent of the electronic piano it is designed to be mounted on.

In the processing unit of the teaching device according to the first aspect of the invention, the electronic control module processes data that are transmitted by the remote peripheral terminal. The electronic control module converts this data so that the light-emitting strip visually guides with lights when said light-emitting strip is mounted on the keyboard of an electronic piano. Of course, this data can be of any kind, for example digital data.

In the processing unit of the teaching device according to the first aspect of the invention, the electronic control module is configured to be driven by a remote peripheral terminal. The remote peripheral terminal is remote in that it is distinct from the teaching device according to the invention. It shall be understood that the electronic control module is, as such, without a monitoring display. It shall be understood that the processing unit is, as such, without a monitoring display. A monitoring display that is a monitoring interface of the electronic control module is offset on the remote peripheral terminal. The remote peripheral terminal comprises the monitoring display. An example of remote peripheral terminal can be a computer, a digital tablet and/or a telephone.

In the teaching device according to the first aspect of the invention, the data from the remote peripheral terminal is transmitted to a user by the electronic control module in a luminous form. The data from the remote peripheral terminal is transmitted by the electronic control module with lights at the flexible light-emitting strip.

In the teaching device according to the first aspect of the invention, the light-emitting strip is configured to be mounted on the keyboard of an electronic piano. When the light-emitting strip is mounted on the keyboard of the piano, the light-emitting strip can be implemented to guide a user when learning the piano. When the light-emitting strip is dissociated from the keyboard of the piano, the light-emitting strip can be stored. By “mounted”, it shall be understood that the light-emitting strip is designed to cooperate with the keyboard of the electronic piano. In a first embodiment, the light-emitting strip is designed to be laid onto keys that constitute the keyboard of the piano. In a second embodiment, the light-emitting strip is designed to be laid onto a casing of the piano that comprises the keyboard and along the keyboard of the electronic piano. In a third embodiment, the light-emitting strip is designed to be jointly fixed to the casing of the electronic piano and along the keyboard of the electronic piano. In a fourth embodiment, the light-emitting strip is designed to be jointly fixed to the keys that constitute the keyboard of the electronic piano.

In the teaching device according to the first aspect of the invention, the light-emitting strip is configured to generate a visual guidance. When the light-emitting strip is mounted on the keyboard of an electronic piano, the visual guidance shows the user the at least one note to be played.

In the teaching device according to the first aspect of the invention, the light-emitting strip is configured to be mounted on the keyboard of an electronic piano. The light-emitting strip is configured to be laid onto the keyboard so that it is aligned with said keyboard. As a rule, when the light-emitting strip is mounted on the keyboard of the piano, the light-emitting strip and the keyboard extend along a substantially equivalent direction. In this configuration, the light-emitting strip is configured to independently identify each key of the keyboard of the electronic piano, so that the user identifies the at least one note to be played.

In the teaching device according to the first aspect of the invention, the light-emitting strip is flexible. By flexible, it shall be understood that the light-emitting strip is provided with flexibility. The flexible light-emitting strip can bend. It shall be understood that the flexible light-emitting strip can bend without breaking. The flexible light-emitting strip can be rolled and/or folded. In particular, the flexible light-emitting strip can be rolled and/or folded for storage and/or stocking. It shall be understood that, when it is implemented and mounted on the keyboard of the electronic piano, the light-emitting strip extends level on the keyboard. When level, the light-emitting strip is straight. In other words, when level, the light-emitting strip has no curve. According to the way it is used, the flexible light-emitting strip can be straight or folded and/or rolled.

In the teaching device according to the first aspect of the invention, the light-emitting strip is removably connected to the processing unit by cabling. When removably connected to the processing unit by cabling, the light-emitting strip can be disconnected from the processing unit. In other words, the processing unit and the light-emitting strip can be disconnected from each other without harming their respective integrity. The light-emitting strip can be disconnected from the processing unit for optimal storage and/or stocking of the light-emitting strip, of the processing unit and of the cabling. With a light-emitting strip removably connected to the processing unit, the storage and the stocking of the teaching device are advantageously made easier. Such a configuration provides compacity to the teaching device when it is stored and/or stocked. Furthermore, such a configuration makes the maintenance of the teaching device easier. In particular, when the light-emitting strip has to be replaced, or when the user wants to modify it, a light-emitting strip removably connected to the processing unit is particularly advantageous. It's also true when the processing unit needs to be repaired.

Such a removable teaching device with a flexible removable light-emitting strip and an electronic control module without a control display makes it possible to guarantee the modularity and compacity of said device. It can be associated with any remote peripheral terminal provided with a control display and compatible with the electronic control module. Thus, this solution makes it possible to share the same teaching device between several electronic pianos while being easy to implement. The teaching device according to the invention has the advantage of alleviate the drawbacks above. The teaching device according to the invention is furthermore space-saving when dismantled, which makes it easy to move, to store and to maintain.

The control process according to the first aspect of the invention advantageously comprises at least one of the following refinements, wherein the technical characteristics of these refinements can be adopted alone or in combination:
the electronic control module comprises a communication interface that makes it possible to establish a two-way wireless communication between the processing unit and the remote peripheral terminal. The communication interface is designed to allow a transmission of at least one signal. The at least one signal is advantageously radiowave-type. Advantageously, the at least one signal is a WIFI signal. Alternatively or complementarily, the at least one signal is a Bluetooth signal. As a rule, the communication interface is designed to allow a transmission of at least one signal between the processing unit and the remote peripheral terminal. For example, the communication interface allows the remote peripheral terminal to receive a signal from the processing unit to the remote peripheral terminal. Complementarily, the communication interface allows the remote peripheral terminal to receive the at least one signal from the remote peripheral terminal to the processing unit. In that sense, the communication is two-way. The wireless communication makes it possible to wirelessly network the processing unit and the remote peripheral terminal. In other words, the communication interface is configured to wirelessly pair with a remote receptor of the remote peripheral terminal and/or a remote emitter of the remote peripheral terminal.

The communication interface is configured to simultaneously or alternatively pair with a remote receptor of the remote peripheral terminal and/or a remote emitter of the remote peripheral terminal;
the communication interface comprises a WIFI-type telecommunication antenna. The communication antenna is designed to emit and/or receive at least one signal. A WIFI-type telecommunication antenna is configured to emit and/or receive a very high frequency radio signal between 2.4 and 5 GHz as defined in the standard IEEE802.11. Such a WIFI-type telecommunication antenna makes it possible to connect the communication interface to the short- and/or long-range remote peripheral terminal. In particular, such a WIFI-type telecommunication antenna offers a longer connection range than a Bluetooth-type telecommunication antenna;
Complementarily or alternatively, the communication interface comprises a Bluetooth-type telecommunication antenna. The communication antenna is designed to emit and/or receive at least one signal. A Bluetooth-type telecommunication antenna is configured to emit and/or receive a very high frequency radio signal between 2.4 and 2.485 GHz as defined in the standard IEEE802.15.1. Such a Bluetooth-type telecommunication antenna makes it possible to connect the communication interface to the short-range remote peripheral terminal. In particular, such a Bluetooth-type telecommunication antenna offers a shorter connection range than a WIFI-type telecommunication antenna;
the electronic control module comprises a support on which are jointly fixed and electrically connected a light source that is configured to emit at least one light signal, a switch and a processing element configured to interface the switch and the at least one light signal. In the electronic control module, the support is jointly fixed to the light-emitting source, to the switch and to the processing element. In the electronic control module, the light-emitting source, the switch and the processing element are electrically connected with each other. In the electronic control module, the support is, for example, a PCB or a programmable board. In the electronic control module, the light-emitting source is configured to emit at least one light signal. The at least one light signal is emitted by a source such as a light-emitting diode (LED) or a micro light-emitting diode (micro-LED). The light-emitting source is configured to transmit visual information to the user of the teaching device according to the invention. In the electronic control module, the switch is configured to alternatively switch off or on the electronic control module, in particular in the light-emitting source. The switch is designed to be activated by an user. In the electronic control module, the processing element is configured to electrically connect the switch and the at least one light signal. It shall be understood that, according to the implemented invention, the peripheral terminal makes it possible to drive all the functions of the teaching device other than those the switch allows, which means that all the functions of the teaching device other than turning off or on the electronic control module;
advantageously, the light-emitting source is configured to emit a first light signal and a second light signal. Different emitted light signals make it possible to specify the user different states of implementation of the teaching device according to the invention. For example, the first light signal is a light signal of a first color and the second light signal is a light signal of a second color distinct from the first color. For example, the first color is green and the second color is white. For example, the first color is emitted by the light-emitting source at the start of the teaching device according to the invention, in other word when setting function, and the second color is emitted by the light-emitting source when the teaching device according to the invention has been started, in other word when it is functioning;
the processing element is electrically connected to the communication interface, the processing element being configured to interface the communication interface and the light-emitting source. It shall be understood that the at least one light signal emitted by the light-emitting source makes it possible to show the state of connection between the communication interface and the remote peripheral terminal. For example, the light-emitting source is configured to emit a third light signal. The third color is a light signal with a third color. For example, the third color is blue. The third color is emitted by the light-emitting source when the communication interface and the remote peripheral terminal are connected with each other. For example, the light-emitting source is configured to emit a fourth light signal distinct from the third light signal. The fourth color is a light signal with a fourth color. For example, the fourth color is red. The fourth color is emitted by the light-emitting source to report an error;
the electronic control module comprises a connection system designed to connect the processing unit to the electronic piano. The connection system can be a wired or wireless connection system;
the connection system is a wired connection system designed to be connected to a USB connector of the processing unit and/or to a micro-USB connector of the processing unit. “USB” refers to the acronym “Universal Serial Bus”. For example, the connection system comprises a cable designed to be connected, on one hand, to the USB or micro-USB connector of the processing unit, and on the other hand, to a “USB to host” port of the electronic piano or to a MIDI port of the electronic piano. The connection system can comprise an adapter between the processing unit and the electronic piano. The adapter is advantageously a “micro-USB to USB port” adapter. Alternatively, the connection system is a wireless connection system comprising an antenna, advantageously a MIDI data transceiver antenna, and an adapter, advantageously a MIDI data transceiver adapter. The adapter of the wireless connection system is distinct from the casing. The antenna of the wireless connection system is integrated to the casing and included in the processing unit. The adapter of the wireless connection system is designed to be connected to a “USB to host” port of the electronic piano or to a MIDI port of the electronic piano;
the support takes the form of a sheet or a plate. Then, the support is a substantially level part that extends in a main plane. Such a support spares place for the invention;
the support is advantageously a PCB;
the casing of the processing unit comprises a display unit of the at least one light signal and houses the light-emitting source. The casing of the processing unit houses the light-emitting source. By houses, it shall be understood that the light-emitting source is fully or partly contained in the casing of the processing unit. Advantageously, the light-emitting source is fully contained in the casing of the processing unit. The display unit makes it possible to display the at least one light signal. The display unit can take any form compatible with the at least one light signal. For example, the display unit is delineated by the frame of a distinctive sign. In particular, such a distinctive sign allows the user, by visual recognition, to identify the teaching device according to the invention. For example, the distinctive sign is a mark, for example a figurative mark. According to another example, the display unit comprises a representation of the distinctive sign. Advantageously, the representation of the distinctive sign is designed to be lighted up by the light-emitting source.
the display unit is made of at least a translucent wall of the casing. Such a display unit makes it possible to display an emission of light by the light-emitting source. The word translucent refers to a wall of the casing that lets light through while the user cannot clearly distinguish the outline of the light-emitting source. Alternatively or complementarily, the display unit is made of at least a transparent wall of the casing. The word transparent refers to a wall of the casing that lets light through and lets the user clearly distinguish the outline of the light-emitting source. Alternatively, the display unit is made of a plurality of translucent walls that constitute the casing;
advantageously, the at least one translucent wall of the casing is delineated by the outline of the distinctive sign. In particular, such a distinctive sign allows the user, by visual recognition, to identify the teaching device according to the invention. For example, the distinctive sign is a mark, for example a figurative mark. According to another example, the at least one translucent wall of the casing comprises a representation of the distinctive sign. Advantageously, the representation of the distinctive sign is designed to be lighted up by the light-emitting source;
the casing of the processing unit comprises a memory zone electrically connected to the electronic control module. The memory zone makes it possible to store digital data. In particular, the memory zone makes it possible to store an operation software of the teaching device according to the invention. In particular, such a software makes it possible to convert digital data into a visual guidance at the light-emitting strip;
the memory zone is of memory card type. The memory card makes the memory zone compact and lightweight. The memory card makes the memory zone spare storage and saving space. The memory card makes the memory zone gain reliability by resisting the mechanical damages. For example, the memory zone is of SD card type or micro-SD card type. SD means “Secure Digital”;
the casing of the processing unit is made by die casting. This industrial shaping process also makes it possible to produce many identical items at lower cost by repetition of the use of the same mould;
the casing of the processing unit is made of a plastic material. For example, the casing of the processing unit is made of a polymer. Advantageously, the casing of the processing unit is made of a biobased polymer. An example of biobased polymer is polylactic acid (PLA). Such a polymer is advantageously biodegradable in industrial composting. Such a polymer is advantageously synthetized from renewable resources;
the teaching device is designed to be electrically connected to a power supply source. In particular, the processing unit is designed to be electrically connected to a power supply source. The power supply source makes it possible to provide power to the teaching device according to the invention. In particular, the power supply source provides power to the light-emitting strip through the wired communication system. For example, the power supply source is a mains socket;
the teaching device comprises a transformer. The transformer is designed to be located between the power supply source and the processing unit. For example, the transformer is a 5V 3A transformer;
the processing unit comprises a feed port designed to be electrically connected to a power supply source. The feed port makes it possible to connect the processing unit to the power supply source;
the flexible light-emitting strip is designed to be fixed to the electronic piano with a removable fixing means. The removable fixing means makes it possible to position the light-emitting strip on the electronic piano. The removable fixing means makes it possible to take the light-emitting strip and the electronic piano apart without harming the integrity of either one of these elements. The removable fixing means makes it possible to position the light-emitting strip, so that it matches the keys of the keyboard each time the user wants to implement the invention to play the piano. The removable fixing means is advantageously fixed jointly to a bottom of the casing;
the removable fixing means comprises an adhesive tape and/or a magnet and/or an self-gripping tape. An adhesive tape makes it possible to quickly fix the light-emitting strip to the electronic piano or to fix the magnet and/or the self-gripping tape. The adhesive tape is, for example, a double-sided tape jointly fixed to the support face of the light-emitting strip. The magnet makes the fixing and separation of the light-emitting strip onto the electronic piano easier. The self-gripping tape makes it possible to quickly fix and separate the light-emitting strip to and from the electronic piano. The self-gripping tape makes the repositioning of the light-emitting strip on the electronic piano easier. The self-gripping tape is, for example, of Velcro-type. For example, the light-emitting strip is jointly fixed to the electronic piano with a removable fixing means that comprises a magnet with an adhesive face;
the flexible light-emitting strip comprises a light-emitting source such as several light-emitting diodes aligned along an extension axis of the light-emitting strip. The electronic control module converts the data from the remote peripheral terminal so that the light-emitting strip provides a visual guidance with lights at the light-emitting source. In the light-emitting strip, the light-emitting source is configured to visually guide to at least one note to be played. The light-emitting source is advantageously implemented when the light-emitting strip is mounted on the keyboard of the electronic piano. In the light-emitting strip, the light-emitting source comprises several light-emitting diodes (LEDs). The light from the light-emitting source is modulated according to the data from the remote peripheral terminal. At least one of the light-emitting diodes of the light-emitting strip is designed to identify a key of the electronic piano, on which the light-emitting strip is mounted and implemented. The extension axis of the light-emitting strip is designed to extend substantially parallel to the keyboard of the electronic piano. By substantially, it shall be understood that the extension axis of the light-emitting strip is designed to extend substantially parallel to the keyboard of the electronic piano more or less 10%. By being aligned along the extension axis of the light-emitting strip, the light-emitting diodes are mounted opposite the note they show when the invention is implemented on the electronic piano. When the light-emitting strip is implemented on the electronic piano, each key that the user must press to play it is identified by an emission of light at the at least one of the corresponding light-emitting diodes;
each of the light-emitting diodes of the source of the light-emitting strip is configured to be independently operable. Alternatively or complementarily, when several light-emitting diodes make it possible to use a same key of the electronic piano, on which the light-emitting strip is implemented, wherein said light-emitting diodes are configured to be operable in a synchronized way;
each light-emitting diode is a RGB-type light-emitting diode. RGB is the acronym for “red green blue”. Each RGB light-emitting diode constitutes a multicolored diode in the source of the light-emitting strip. Such a RGB light-emitting diode is configured to emit, by variable proportions of emission of red, green and blue light, all the colors of the light spectrum. Such a RGB light-emitting diode is configured to emit white light, with equal proportions of red, green and blue light. As a rule, in a same light-emitting strip, all light-emitting diodes are of the same type. The light-emitting strip makes it possible to generate light effects with each of the light-emitting diodes according to the MIDI data. For example, the light effects are of the type of the light appearing directly and/or fading in and/or with a given intensity. For example, the light effects can be proportional to a velocity. For example, the light effects can correspond to a given scale with a given color. In particular, an emission of green light corresponds to keys of a given scale and an emission of red light corresponds to the other keys. In particular, an emission of multicolor lights or of lights in a gradient can be generated at the light-emitting diodes of the light-emitting strip;
in the light-emitting source, two immediately contiguous light-emitting diodes constitute a pair of light-emitting diodes, each pair of light-emitting diodes of the light-emitting strip being configured to visually guide to an unique note to be played when said light-emitting strip is associated to a keyboard of the electronic piano. It shall be understood that each pair of light-emitting diodes makes it possible to identify a same key of the electronic piano, on which the light-emitting strip is implemented. In the pair, the light-emitting diodes are aligned with the key it corresponds. Each pair of light-emitting diodes is configured to be operable in a synchronized way. In this configuration, a key is identified by an increased light intensity relatively to a configuration where only one light-emitting diode identifies a key;
the flexible light-emitting strip has an adjustable size relatively to the number of keys of the keyboard of the electronic piano. This way, the length of a flexible light-emitting strip is adjustable. For example, the flexible light-emitting strip is divisible. Since it is divisible, the light-emitting strip can easily be adapted to the needs of the user. Before cutting, such a light-emitting strip is versatile and can be adapted to any type of keyboard. In this configuration, it is possible to manufacture many identical units of the teaching device according to the first aspect of the invention, and the user can choose to adapt the length of the divisible light-emitting strip. It shall be understood that dividing the light-emitting strip is an irreversible action. However, once cut, the length of the light-emitting strip can still be reduced, if necessary;
the light-emitting source comprises 88 pairs of light-emitting diodes. Such a light-emitting source is suitable for a 88-key electronic piano. Such a light-emitting source is also suitable for a less than 88-key electronic piano;
the light-emitting source comprises 66 pairs of light-emitting diodes. Such a light-emitting source is suitable for a 66-key electronic piano. Such a light-emitting source is also suitable for a less than 66-key electronic piano.

According to a second aspect of the invention, it is set forth a teaching set for electronic piano, wherein the teaching set comprises: (i) the teaching device according to the first aspect of the invention or according to any one of its refinements, defined to be connected to an electronic piano by a connection system; (ii) the electronic piano; (iii) a MIDI/USB interface configured for a two-way communication between the electronic piano and the processing unit; (iv) a remote peripheral terminal connected to the teaching device by a two-way wireless communication, the remote peripheral terminal comprising a monitoring display designed to monitor the teaching device.

The teaching set according to the second aspect of the invention is designed to help a user learn the electronic piano. In the teaching set according to the second aspect of the invention, the teaching device constitutes a teaching appliance designed for mounting on the electronic piano.

In the teaching set according to the second aspect of the invention, the teaching device is designed to be connected to the electronic piano by the connection system of the teaching device. The connection system allows a two-way communication between the processing unit and the electronic piano. The connection system is designed to be connected, on one hand, to the USB or micro-USB connector of the processing unit, and on the other hand, to a “USB to host” port of the electronic piano or to a MIDI port of the electronic piano. When the connection system is a wireless connection system, the antenna of the wireless connection system is integrated to the casing and included in the processing unit. The adapter of the wireless connection system is connected to a “USB to host” port of the electronic piano or to a MIDI port of the electronic piano;

The teaching set according to the second aspect of the invention comprises the electronic piano. The electronic piano can be a digital piano. The electronic piano is an electronic musical instrument. The electronic piano comprises a “USB to host” port and/or a MIDI port. The invention is compatible with any type of electronic piano. According to the invention, the teaching device reversibly turns any electronic piano into an electronic musical instrument dedicated to teaching the piano. The electronic pianos compatible with the invention can be, non limitatively, any one of the following models: Yamaha P 125, Yamaha P45, Clavinova by Yamaha, Kawai ES110, the electronic pianos of the Nord and Korg series.

In the teachins set according to the second aspect of the invention, the MIDI/USB interface is configured for a two-way communication between the electronic piano and the processing unit. The electronic piano advantageously comprises the MIDI/USB interface. Alternatively, the MIDI/USB interface is configured for a wired connection to the electronic piano, in particular when said electronic piano has no USB port.

In the MIDI/USB interface of the teaching set according to the second aspect of the invention, “MIDI” refers to the acronym for “Musical Instrument Digital Interface”. “USB” refers to the acronym “Universal Serial Bus”. The USB connector and/or the micro-USB connector of the connection system is compatible with the MIDI/USB interface of the electronic piano. The connection system allows an exchange of data between the electronic piano and the processing unit. The MIDI/USB interface of the electronic piano allows an exchange of MIDI data between the electronic piano and the processing unit when the electronic piano and the processing unit are connected by a connection system. MIDI data is musical data. In other words, MIDI data constitutes a language that allows computers, musical instruments and other types of electronic materials to communicate. The MIDI protocol includes the interface, the language in which the MIDI data is transmitted and the required connections to communicate between material items. Among the MIDI data, there is, for example: data that specifies whether a key is pressed or released (ON or OFF), data relative to “pitches” (how high or low the sound is), data relative to the played notes, data relative to a velocity (how fast or when the key is pressed), data relative to the “aftertouch” (which pressure is applied to the key), data relative to the “tempo” as measured in beats per minute (in reference to the acronym BPM), data relative to the “panning” (adjustment of the panoramic distribution in the stereo or multichannel space), data relative to the modulations, data relative to the volume, . . . .

In the teaching set according to the second aspect of the invention, the light-emitting strip is configured to be laid onto the keyboard so that it is substantially aligned with said keyboard. It shall be understood that, when it is implemented and mounted on the keyboard of the electronic piano, the light-emitting strip extends level on the keyboard. When level, the light-emitting strip is straight. In other words, when level, the light-emitting strip has no curve. The light-emitting strip advantageously extends level on the keyboard and is jointly fixed on said keyboard by a removable fixing means of the teaching device.

In the teaching set according to the second aspect of the invention, the electronic piano comprises a casing, a keyboard that comprises a plurality of keys designed to be mechanically operated, and a loudspeaker able to generate acoustic vibrations that are at least partly received by said casing. When a user mechanically operates one of the keys, in other words when they press one of the keys, acoustic vibrations and MIDI data are generated.

In the teaching set according to the second aspect of the invention, the electronic control module processes the MIDI data that is transmitted by the remote peripheral terminal. The electronic control module converts this MIDI data so that the light-emitting strip visually guides with lights representative of the MIDI data.

In the teaching set according to the second aspect of the invention, the electronic control module is configured to be driven by the remote peripheral terminal. The remote peripheral terminal comprises a monitoring display designed to monitor the teaching device. The remote peripheral terminal is remote from the teaching device in that it is distinct from the teaching device. The monitoring display of the remote peripheral terminal constitutes a monitoring interface of the electronic control module that is offset on the remote peripheral terminal. The remote peripheral terminal advantageously makes it possible to connect to the Internet. An example of remote peripheral terminal can be a computer, a digital tablet and/or a telephone.

In the teaching set according to the second aspect of the invention, the data from the remote peripheral terminal is converted by the electronic control module, so that light is emitted at the flexible light-emitting strip.

In the teaching set according to the second aspect of the invention, when the light-emitting strip is mounted on the keyboard of an electronic piano, the teaching set can be implemented to generate a visual guidance show the user the at least one note to be played.

Such a teaching set with a movable teaching device makes it possible to autonomously learn the electronic piano in an playful way. This easy solution makes learning the piano easier by associating said electronic piano to the teaching device via the MIDI/USB interface and a remote terminal. The teaching set according to the invention has the advantage of alleviate the drawbacks above.

The teaching set according to the second aspect of the invention advantageously comprises at least one of the following refinements, wherein the technical characteristics of these refinements can be adopted alone or in combination:
each key of the keyboard is associated with one of the pairs of light-emitting diodes of the light-emitting strip. By “associated”, it shall be understood that a pair of diodes identifies a key by lying opposite of said key. In other words, each key of the keyboard is in a proximal position to the pair of diodes that identifies it. When the light-emitting strip is mounted on the keyboard, the corresponding pair of diodes lies over each key. The light-emitting strip is mounted on the keyboard of an electronic piano, so that a pair of light-emitting diodes of the light-emitting strip is mounted opposite to one of the keys of the keyboard. In this configuration, the light-emitting strip mounted on the keyboard of the electronic piano can generate a visual guidance to identify a key to be played, so that a user is prompted to play the corresponding note by pressing said key to play;
the remote peripheral terminal is configured to read MIDI data. For example, the remote peripheral terminal is equipped with some software to read MIDI data. An example of software to read MIDI data is Synthesia;
the remote peripheral terminal is configured to implement an application. The application is a dedicated application or a web application (Web APP). When implemented and no matter its nature, the application can be operated via the remote peripheral terminal. The monitoring display of the remote peripheral makes it possible to drive the implemented application.
the remote peripheral terminal is configured to connect to the Internet. When connected to the Internet, the remote peripheral terminal can access the web application. When implemented, the web application can be managed directly online via a web navigator. The monitoring display of the remote peripheral makes it possible to drive the implemented web application.
the application is configured to manage MIDI data. The monitoring display of the remote peripheral makes it possible to manage MIDI data with the application;
the teaching device is configured to convert MIDI data from the application into a visual guidance at the light-emitting strip;
the remote peripheral terminal is configured to record MIDI data. In particular, the remote peripheral terminal makes it possible to record MIDI data that are generated at the electronic piano. Recording MIDI data that are generated at the electronic piano allows the learning user to improve their performances by monitoring their progress;
the remote peripheral terminal is configured to set up the source of the light-emitting strip. It shall be understood that the application makes it possible to set up the emission characteristics of the light-emitting diodes. For example, the application makes it possible to select the at least one color emitted by the light-emitting diodes of the source and/or their intensity and/or their mode of lighting up;
the remote peripheral terminal comprises a WIFI-type telecommunication antenna. The communication antenna is designed to emit and/or receive at least one signal. A WIFI-type telecommunication antenna is configured to emit and/or receive a very high frequency radio signal between 2.4 and 5 GHz as defined in the standard IEEE802.11. Such a WIFI-type telecommunication antenna makes it possible to connect the remote peripheral terminal to the short- and/or long-range communication interface. In particular, such a WIFI-type telecommunication antenna offers a longer connection range than a Bluetooth-type telecommunication antenna. Complementarily or alternatively, the remote peripheral terminal comprises a Bluetooth-type telecommunication antenna. The communication antenna is designed to emit and/or receive at least one signal. A Bluetooth-type communication antenna is configured to emit and/or receive a very high frequency radio signal between 2.4 and 2.485 GHz as defined in the standard IEEE802.15.1. Such a Bluetooth-type telecommunication antenna makes it possible to connect the remote peripheral terminal to the short-range communication interface. In particular, such a Bluetooth-type telecommunication antenna offers a shorter connection range than a WIFI-type telecommunication antenna.

According to a third aspect of the invention, it is set forth a teaching process for electronic piano that implements the teaching set, wherein the process comprises the following steps:
(i) a monitoring step of the teaching device by the remote peripheral terminal,
(ii) a configuration step of the teaching device thanks to the remote peripheral terminal,
(iii) a digital data transmission step from the remote peripheral terminal to the teaching device,
(iv) a visual guiding step, wherein the digital data transmitted by the remote peripheral terminal is converted into light at the light-emitting strip at the visual guiding step.

In the process according to the third aspect of the invention and during the monitoring step, the remote peripheral terminal implements an application, where the digital data comes from. When the application is a web application, the application can be driven directly online. The configuration step is made advantageously before the monitoring step.

In the process according to the third aspect of the invention, the configuration step of the teaching device makes it possible to set up the teaching device, in particular the light-emitting strip. In particular, the configuration step of the teaching device makes it possible to set up the number of keys of the electronic piano. In particular, the configuration step of the teaching device makes it possible to set up a direction of the light-emitting strip. In particular, the configuration step of the teaching device makes it possible to set up which MIDI data to use. The configuration step of the teaching device is advantageously driven by the application;

In the process according to the third aspect of the invention, the monitoring step of the teaching device by the remote peripheral terminal makes it possible to drive the teaching device thanks to the remote peripheral terminal.

In the process according to the third aspect of the invention, the digital data transmission step from the remote peripheral terminal to the teaching device makes it possible to communicate data to the teaching device thanks from the remote peripheral terminal.

In the process according to the third aspect of the invention, the visual guiding step makes it possible to light up at least one of the light-emitting diodes of the light-emitting strip, the lighting up depending on data transmitted to the teaching device by the remote peripheral terminal. During the visual guiding step, a user is prompted to play the right note at the right moment. In other words, the visual guiding step makes it possible to guide the user of the electronic piano in space.

The process according to the third aspect of the invention advantageously comprises at least one of the following refinements, wherein the technical characteristics of these refinements can be adopted alone or in combination:
the process according to the invention comprises a step of mounting the teaching device to the electronic piano. In the process according to the third aspect of the invention, the mounting step of the teaching device to the electronic piano makes it possible to have the teaching device cooperate with the electronic piano. During the mounting step of the teaching device to the electronic piano, the teaching device is assembled and the light-emitting strip is mounted to the electronic piano. This step makes it possible to position the light-emitting strip, so that it matches the keys of the keyboard. For example, during the mounting step, the light-emitting strip is fixed to the electronic piano with a removable fixing means. This step further makes it possible to fix the light-emitting strip to the processing unit via the cabling of the light-emitting strip;
the process according to the invention comprises a step of turning on the teaching device. In the process according to the third aspect of the invention, the turning on step of the teaching device makes it possible to turn on the powered teaching device;
the process according to the invention comprises a step of pairing the teaching device and the remote peripheral terminal. In the process according to the third aspect of the invention, the pairing step between the teaching device and the remote peripheral terminal makes it possible to connect the teaching device to the remote peripheral terminal;
the configuration step of the teaching device by the remote peripheral terminal comprises a step of customization of the visual guidance. The customization step of the visual guidance makes it possible to set up the light-emitting strip. More specifically, the customization step of the visual guidance makes it possible to set up the light-emitting strip by selecting the colors emitted by said light-emitting strip and/or the light effects generated by said light-emitting strip. The customization step of the visual guidance is advantageously driven by the application;
the process comprises a step of indication of the power supply to the teaching device. For example, an absence of power supply is specified by an absence of light signal at the light-emitting source and/or a start of the teaching device is specified by a first light signal at the light-emitting source and/or a second light signal at the light-emitting source that is distinct from the first light signal, shows that the teaching device has been launched;
the process comprises a step of display of at least one connection status between the teaching device and the remote peripheral terminal. For example, a third light signal shows that a telecommunication between the teaching device and the remote peripheral terminal has been established;
the process comprises (i) a step of plugging of the electronic piano to the teaching device via the MIDI/USB interface; (ii) a step of control of the speed of the visual guidance conditioned by the achievement of a step of plugging. During the step of control of the speed of the visual guidance, the guidance by the lights is a function of the mechanical activation of the keys. In other words, to play the at least one note given from the MIDI data, at least one key to mechanically operate is identified by a first specific emission of light at the light-emitting strip. The at least one following note is identified by a second specific emission of light at the light-emitting strip after the at least one key has been activated. Without mechanical activation of the at least one key, the light-emitting strip emits according to the first light emission. In other words, the step of control of speed of the visual guiding makes it possible, at the moment of the visual guidance step, to guide the user of the electronic piano in time;
the process comprises, after the step of plugging by the MIDI/USB interface of the electronic piano, a step of recording by the teaching device of at least one piece of musical data, wherein the recording step happens when the at least one note is played on the electronic piano. The recording step makes it possible to record data into the memory zone of the teaching device.

There are various embodiments of the invention that integrate the different optional characteristics specified here according to their possible combinations.

Other characteristics and advantages of the invention will appear thanks to the following description, on one hand, and thanks to several embodiments produced as a guide and non-limitative with a reference to the appended schematic pictures, on the other hand, where:

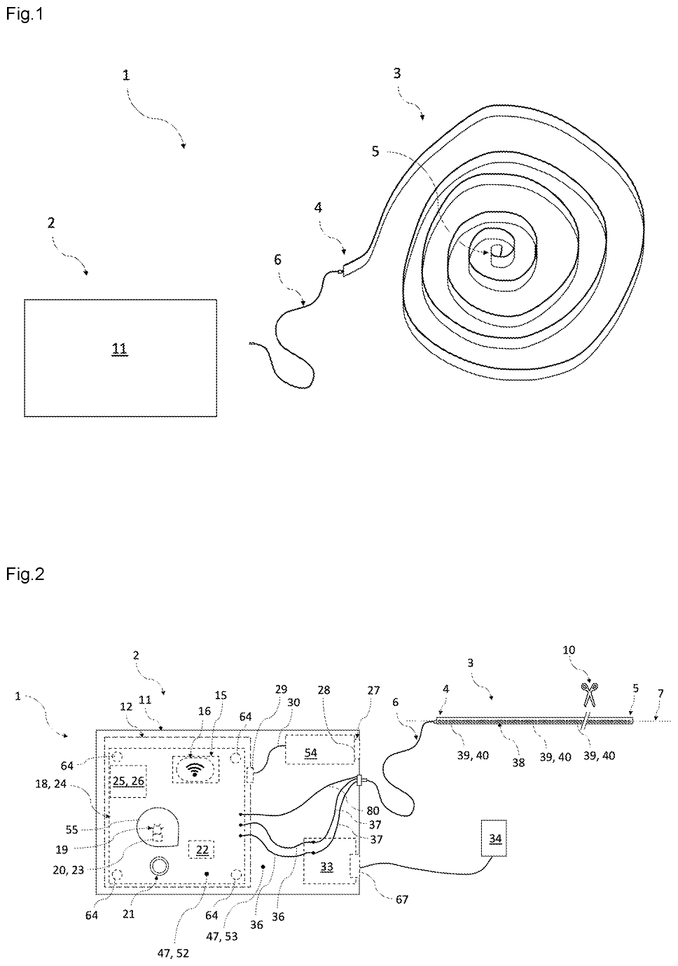

FIG. 1 shows a schematic view of a teaching device for electronic piano, the teaching device being according to the first aspect of the invention;

FIG. 2 shows a detailed schematic view of the teaching device shown in FIG. 1;

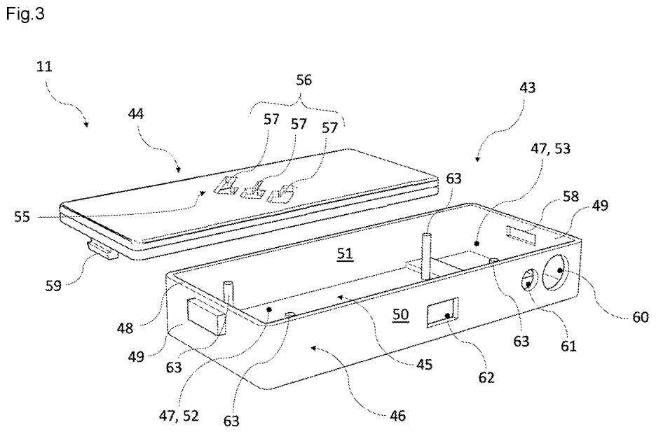

FIG. 3 shows a schematic view of a casing in the teaching device according to the first aspect of the invention as shown in FIG. 1;

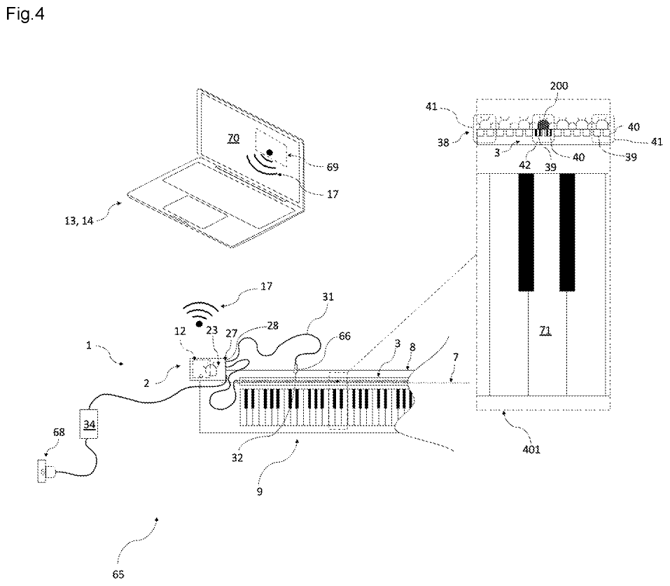

FIG. 4 shows a schematic view of a teaching set for electronic piano according to the second aspect of the invention;

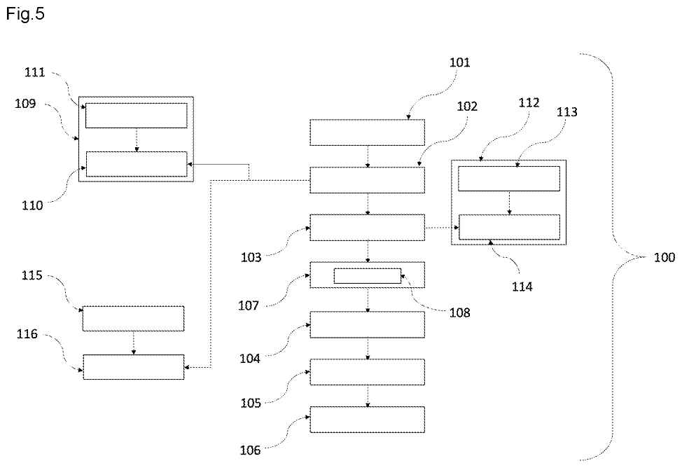

FIG. 5 shows a teaching process for electronic piano that implements the teaching set according to the second aspect of the invention shown in FIG. 4, wherein the teaching process is according to the third aspect of the invention.

Of course, the characteristics, the variants and the various embodiments of the invention can be associated under various combinations, as far as they are not mutually incompatible or exclusive. You could conceive variants of the invention, which only include a selection of characteristics as described below, apart from the other describe characteristics, as far as this selection of characteristics is enough to give a technical advantage or to distinguish the invention from the previous state of the art.

In particular, all described variants and embodiments can be associated if it is technically possible.

On the figures, common items to several figures keep the same reference.

With reference to FIGS. 1 and 2, a schematic view of the teaching device 1 for electronic piano is pictured. The teaching device 1 is according to the first aspect of the invention.

FIGS. 1 and 2 show that the teaching device 1 according to the first aspect of the invention comprises a processing unit 2 and a flexible light-emitting strip 3. In FIG. 2 in particular, and in FIG. 1 more generally, the dimensional proportions between the processing unit 2 and the flexible light-emitting strip 3 are not respected to make the comprehension of the invention easier.

In FIG. 1, the flexible light-emitting strip 3 is shown separated from the processing unit 2. The light-emitting strip 3 comprises a first end 4 opposite the second end 5. The first end 4 of the light-emitting strip 3 extends with a cabling 6 of the light-emitting strip 3. It shall be understood in FIG. 2 that the cabling 6 of the flexible light-emitting strip 3 makes it possible to removably link said light-emitting strip 3 to the processing unit 2.

FIG. 1 shows that the light-emitting strip 3 is flexible and rolled. The flexible light-emitting strip 3 can be rolled for storage. FIG. 2 shows a flexible light-emitting strip 3 that extends between the first end 4 of the light-emitting strip 3 and the second end 5 of the light-emitting strip 3 along an extension axis 7 of the light-emitting strip 3. The light-emitting strip 3 that extends along the extension axis 7 can be implemented to learn the electronic piano, as shown in FIG. 4, by mounting on the keyboard 8 of an electronic piano 9. It shall be understood that the light-emitting strip 3 is configured to visually guide to at least one note to be played when said light-emitting strip 3 is mounted on the keyboard 8 of the electronic piano 9 as pictured in FIG. 4. The light-emitting strip 3 is fixed to the electronic piano 9 with a not pictured removable fixing means. The removable fixing means secures a right relative position between the light-emitting strip 3 and the keyboard 8 of the electronic piano 9.

FIG. 2 shows that the light-emitting strip 3 is divisible. The divisible character of the light-emitting strip 3 is shown by scissors 10.

In the teaching device 1 according to the first aspect of the invention as shown in FIGS. 1 and 2, the processing unit 2 comprises a casing 11. In FIG. 2, which shows a details schematic view of the teaching device 1 as shown in FIG. 1, the internal elements of the casing 11 are pictured in dotted lines, except the wired connections, for an easier comprehension of FIG. 2.

In FIG. 2, the casing 11 of the processing unit 2 houses an electronic control module 12. As shown in FIG. 4, the electronic control module 12 is driven by a remote peripheral terminal 13 of laptop-type 14. It shall be understood that the processing unit 2 has no monitoring display, the remote peripheral terminal 13 making it possible to remotely drive the teaching device 1 according to the invention.

FIG. 2 shows that, in the teaching device 1 according to the first aspect of the invention, the electronic control module 12 comprises a communication interface 15 housed in the casing 11 of the processing unit 2. The communication interface 15 comprises a WIFI-type telecommunication antenna 16. The not pictured telecommunication antenna 16 of the communication interface 15 makes it possible to establish a two-way wireless communication between the processing unit 2 and the remote peripheral terminal 13 shown in FIG. 4. FIG. 4 shows that, in the implemented teaching device 1 according to the first aspect of the invention, the processing unit 2 and the remote peripheral terminal 13 are paired and wireless communicate, so that they establish a two-way WIFI signal transmission 17 between the processing unit 2 and the remote peripheral terminal 13.

FIG. 2 shows that, in the teaching device 1 according to the first aspect of the invention, the electronic control module 12 comprises a support 18, on which are jointly fixed a light-emitting source 19 that comprises a light-emitting diode 20, a switch 21 and a processing element 22. Although their connections are not pictured, it shall be understood that the light-emitting source 19, the switch 21 and the processing element 22 are electrically linked with each other via the support 18. The processing element 22 is further electrically connected to the communication interface 15. FIG. 4 shows that, when the teaching device 1 according to the invention has started, the light-emitting diode 20 of the light-emitting source 19 emits a light signal 23. The light-emitting diode is not pictured in FIG. 4. In the electronic control module 12, the light-emitting source 19 is configured to emit at least the light signal 23.

FIG. 2 shows that, in the electronic control module 12 of the teaching device 1 according to the first aspect of the invention, the support 18 takes the form of a PCB 24.

FIG. 2 shows that the casing 11 of the processing unit 2 comprises a memory zone 25 of SD card-type 26. It shall be understood that the memory zone 25 is electrically connected to the electronic control module 12 via the support 18.

FIG. 2 shows that the electronic control module 12 comprises a connection system 27. FIG. 4 shows that the connection system 27 is a wired connection system that connects the processing unit 2 to the electronic piano 9. FIG. 2 shows that the connection system 27 of the electronic control module 12 of the processing unit 2 comprises a USB connector 28 and a micro-USB connector 29 connected to each other through a first electric wire 30 and a “micro-USB to USB port” adapter 54. Indeed, the first electric wire 30 connects the micro-USB connector 29 to the adaptor 54, and the adaptor 54 connects the first electric wire 30 to the USB connector 28. FIG. 4 shows that a cable 31 of the connection system 27 is connected, on one hand, to the USB connector 28 of the processing unit 2, and on the other hand, to a “USB to host” port 32 of the electronic piano 9.

FIG. 2 shows that the processing unit 2 comprises an electric connection terminal 33 electrically connected to a transformer 34 of the teaching device 1 according to the invention via a power supply port 67 of the teaching device 1 according to the invention. The transformer 34 is external to the casing 11 of the processing unit 2. The electric connection terminal 33 is further connected to the support 18 thanks to second wires 36 and to the cabling 6 thanks to third wires 37. Such a configuration makes it possible to supply power to the light-emitting strip 3, on one hand, and to the various components electrically connected with each other via the support 18, on the other hand. Furthermore, a fourth electric wire 80 links the various components electrically connected with each other via the support 18 to the light-emitting strip 3.

FIG. 2 shows that the flexible light-emitting strip 3 comprises a light-emitting source 38 such as several light-emitting diodes 39, 40. The light-emitting diodes 39, 40 of the light-emitting source 38 are aligned along the extension axis 7 of the light-emitting strip 3. Each light-emitting diode 39, 40 is a RGB-type light-emitting diode. A sidebar 401 in FIG. 4 shows that, in the light-emitting source 38 of the light-emitting strip 3, two immediately contiguous light-emitting diodes 39, 40 form a pair 41, 42 of light-emitting diodes 39, 40.

FIG. 3 shows a schematic view of the casing 11 of the processing unit 2 comprised in the teaching device 1 according to the first aspect of the invention. The casing 11 of the processing unit 2 comprises an enclosure 43 and a lid 44 designed to be brought back onto the enclosure 43 and designed to be jointly fixed to the enclosure 43.

FIG. 3 shows that the enclosure 43 comprises a bottom 45 that is jointly fixed to a peripheral wall 46 of the enclosure 43, wherein the bottom 45 and the peripheral wall 46 delineate a housing 47 of the casing 11. The peripheral wall 46 of the enclosure 43 extends perpendicularly to the bottom 45 and comprises a free upper edge 48 opposite to the bottom 45. The peripheral wall 46 comprises two lateral faces 49 opposite to each other and linked by a first face 50 of the peripheral wall 46, on one hand, and by a second face 51 of the peripheral wall opposite to the first face 50 of the peripheral wall 46, on the other hand. It shall be understood that the lid 44 of the casing 11 is designed to be brought back onto the enclosure 43 to close the housing 47 by leaning on the free upper edge 48 of the peripheral 46 of the enclosure 43. Indeed, when the lid 44 closes the enclosure 43, the casing 11 constitutes a parallelepiped.

FIGS. 2 and 3 show that the housing 47 is divided in two spaces 52, 53, a first space 52 and a second space 53. The first space 52 is designed to house the support 18 of the electronic control module 12. The second space 53 is designed to house the adapter 54 and the electric connection terminal 33.

FIG. 3 shows that the casing 11 of the processing unit 2 comprises a display unit 55 of the light signal 23. In the casing 11, as shown in FIG. 2 where the casing 11 is shown from above, the display unit 55 of the light signal 23 lies over the light-emitting source 19 when the casing 11 is closed, in order to have a visualization of the light signal 23 from the light-emitting source 19 through the display unit 55.

In FIG. 3, the display unit 55 is delineated by the frame of a three-part distinctive sign 56. The display unit 55 comprises at least one translucent wall 57 mounted in the lid 44 of the casing 11, in particular of three translucent walls 57 of the casing 11, delineated by the frame of the distinctive sign 56.

FIG. 3 shows that the peripheral wall 46 of the enclosure 43 comprises two lateral cavities 58 opposite to each other, wherein each of them is manufactured in one of the two lateral faces 49 of the peripheral wall 46. The lid 44 of the casing 11 comprises two lateral mounting brackets 59. Only one of the two lateral cavities 58 and only one of the lateral mounting brackets 59 are visible in FIG. 3 because of the viewing angle.

It shall be understood that, to fix the lid 44 of the casing 11 jointly with the enclosure 43 of the casing 11, each of the lateral cavities 58 of the peripheral wall 46 of the enclosure 43 cooperates in a form-fitting manner with one of the lateral mounting brackets 59 of the casing 11.

FIG. 3 shows that the first face 50 of the peripheral wall 46 comprises a first opening 60, a second opening 61 and a third opening 62, wherein each of the openings 60, 61, 62 is a through bore across the peripheral wall 46. The first opening 60 is designed to house the not pictured USB connector 28 of the processing unit 2. The second opening 61 is designed for the passageway of the cabling 6, not pictured, that links the flexible light-emitting strip 3 and the processing unit 2. The third opening 62 is designed for the passageway of the power supply port 67 of the teaching device 1 according to the first aspect of the invention. Not pictured. Indeed, the first opening 60 and the second opening 61 are circular. The third opening 62 is rectangular. The first opening 60 and the second opening 61 are located in a position proximal to one of the lateral faces 49 of the peripheral wall 46 of the enclosure 43. The third opening 62 is located in an intermediary position between the lateral faces 49 of the peripheral wall 46 of the enclosure 43. The second opening 61 is comprised between the first opening 60 and the third opening 62.

FIG. 3 shows that the casing 11 of the processing unit 2 comprises rods 63 protruding from the bottom 45 of the enclosure 43, which extend perpendicularly from the bottom 45 and in the housing 47 of the casing 11. Indeed, the casing 11 comprises four rods 63 that extend around the first space 52 of the housing 47. The four rods 63 are designed to position the PCB 24 by constituting the support 18 of the electronic control module 12, the PCB 24 comprising four holes 64 designed to each be crossed by the four rods 63. The four rods 64 through the PCB 24 that constitute the support 18 of the electronic control module 12 are pictured in FIG. 2.

It shall be understood that the bottom 45 of the enclosure 43 is designed to cooperate with the electronic piano 9, in particular thanks to the removable fixing means jointly fixed to the bottom 45 of the enclosure 43 of the casing 11, on a lower face of the external bottom of the casing 11 and opposite the upper face of the internal bottom of the casing 11.

FIG. 4 shows a schematic view of a teaching set 65 for electronic piano 9 according to the second aspect of the invention. The teaching set 65 according to the invention comprises the teaching device 1 according to the first aspect of the invention, a MIDI/USB interface 66, the electronic piano 9, the remote peripheral terminal 13.

FIG. 4 shows that the processing unit 2 of the teaching device 1 according to the first aspect of the invention is electrically connected to a power supply 68 of the mains type via the transformer 34.

In the teaching set 65 according to the second aspect of the invention as shown in FIG. 4, the teaching device 1 according to the first aspect of the invention is connected to the electronic piano 9 by the wired-type connection system 27 that is electrically connected to the MIDI/USB interface 66 of the electronic piano 9 via the cable 31. The connection system 27 is connected to the USB connector 28 of the processing unit 2.

In the teaching set 65 according to the second aspect of the invention as shown in FIG. 4, the remote peripheral terminal 13 comprises a WIFI-type telecommunication antenna 69. The telecommunication antenna 69 is mounted at the back of a monitoring display 70 of the remote peripheral terminal 13. The telecommunication antenna 69 of the remote peripheral terminal 13 is connected to the telecommunication antenna 16 of the communication interface 15, not pictured. Each telecommunication antenna 16, 69 is designed to emit and receive WIFI signals 17. The monitoring display 70 makes it possible to drive the teaching device 1 according to the first aspect of the invention. In particular, the monitoring display 70 makes it possible to drive the teaching device 1 according to the first aspect of the invention thanks to an application implemented by the remote peripheral terminal 13.

In the teaching set 65 according to the second aspect of the invention as shown in FIG. 4, the extension axis 7 of the light-emitting strip 3 extends parallel to the keyboard 8 of the electronic piano 9. Thus, the light-emitting diodes 39, 40 are mounted opposite the note they identify. The removable not pictured fixing means secures the stability of this mounting.

It shall be understood that, when the light-emitting strip 3 is implemented on the electronic piano 9 as pictured in the first sidebar 401 of FIG. 4, each key 71 of the electronic piano 9 that the user must press to play it is identified by an emission of light 200 at the pair of corresponding light-emitting diodes 39, 40. It shall be understood that the characteristics of the light emission 200 have been previously set up at the remote peripheral terminal 13 thanks to the application. The first sidebar 401 of FIG. 4 shows pairs 41 of turned off light-emitting diodes and a pair 42 of turned on light-emitting diodes, wherein the pair 42 of turned on light-emitting diodes emits light 200. The pair 42 of turned on light-emitting diodes identifies the key 71 to be played on the keyboard 8 of the electronic piano 9.

FIG. 5 shows with a logic chart a teaching process 100 for electronic piano 9 that implements the teaching set 65 according to the second aspect of the invention shown in FIG. 4. The teaching process 100 is according to the third aspect of the invention. In the logic chart of FIG. 5, various steps of the teaching process 100 according to the invention are represented by rectangles. Connections between the various steps of the teaching process 100 according to the invention are represented by straight arrows, which give information, in particular, about a chronology of implementation of the steps.

FIG. 5 shows that the teaching process 100 comprises several successive steps: a mounting step 101 of the teaching device 1 on the electronic piano 9, a turning on step 102 of the teaching device 1, a pairing step 103 between the teaching device 1 and the remote peripheral terminal 13, a monitoring step 104 of the teaching device 1 by the remote peripheral terminal 13, a digital data transmission step 105 from the remote peripheral terminal 13 to the teaching device 1, a visual guidance step 106, where digital data from the remote peripheral terminal 13 are converted to a light form at the pairs 41, 42 of light-emitting diodes 39, 40 of the light-emitting strip 3.

Indeed, FIG. 5 shows that the teaching process 100 according to the third aspect of the invention comprises a configuration step 107 of the teaching device 1 thanks to the remote peripheral terminal 13, wherein the configuration step 107 is implemented before the monitoring step 104. The configuration step 107 of the teaching device 1 thanks to the remote peripheral terminal 13 comprises indeed a customization step 108 of the visual guidance.

Indeed, FIG. 5 shows that the teaching process 100 according to the third aspect of the invention comprises a step of specification 109 of power supply of the teaching device 1, wherein this step happens at the same time as the previous steps. The step of specification 109 of power supply alternatively comprises a step of specification 110 of effective power supply and a step of specification 111 of absence of power supply. The step of specification 110 of effective power supply is conditioned by the implementation of the turning on step 102 of the teaching device 1. The step of specification 111 of absence of power supply is indeed prior to the implementation of the turning on step 102 of the teaching device 1.

Indeed, FIG. 5 shows that the teaching process 100 according to the third aspect of the invention comprises a display step 112 of at least one state of connection between the teaching device 1 and the remote peripheral terminal 13 at the same time as the previous steps. The display step 112 alternatively comprises a specification step 113 of non-connection between the teaching device 1 and the remote peripheral terminal 13 and a specification step 114 of connection between the teaching device 1 and the remote peripheral terminal 13. The specification step 113 of non-connection is prior to the pairing step 103 between the teaching device 1 and the remote peripheral terminal 13. The specification step 114 of connection is conditioned by the implementation of the pairing step 103.

FIG. 5 shows that, indeed, the teaching process 100 according to the third aspect of the invention comprises, after the turning on step 102 of the teaching device 1 and after a step of plugging 115 by the MIDI/USB interface 66 of the electronic piano 9, a step of recording 116 by the teaching device 1 of at least one piece of musical data, wherein the recording step 116 happens when the at least one note is played on the electronic piano 9.

To sum up, the invention relates to a teaching device 1 for electronic piano 9. The teaching device 1 comprises a processing unit 2 and a light-emitting strip 3. The processing unit 2 comprises a casing 11 housing an electronic control module 12 configured to be driven by a remote peripheral terminal 13. The light-emitting strip 3 is flexible and removably connected to the processing unit 2 by a cabling 6, the light-emitting strip 3 being configured to visually guide to at least one note to play when said light-emitting strip 3 is mounted on a keyboard 8 of the electronic piano 9.

Of course, the invention is not restricted to the examples above, and many refinements may be added to these example in the framework of the invention. In particular, the other characteristics, shapes, variants and embodiments of the invention can be associated with one another under various combinations, as far as they are not mutually incompatible and exclusive. In particular, all variants and embodiments above can be associated.

1. A teaching device for electronic piano, the teaching device comprising:
a processing unit comprising a casing housing an electronic control module configured to be driven by a remote peripheral terminal;
a light-emitting strip being configured to visually guide to at least one note to be played when said light-emitting strip is mounted on a keyboard of the electronic piano,
characterized in that the light-emitting strip is flexible and is removably connected to the processing unit by cabling.

2. A teaching device according to claim 1, wherein the electronic control module comprises a communication interface that makes it possible to establish a two-way wireless communication between the processing unit and the remote peripheral terminal.

3. A teaching device according to claim 2, wherein the communication interface comprises a WIFI-type telecommunication antenna.

4. A teaching device according to claim 1, wherein the electronic control module comprises a support on which are jointly fixed and electrically connected a light-emitting source that is configured to emit at least one light signal, a switch and a processing element configured to interface the switch and the at least one light signal.

5. A teaching device according to claim 4, wherein the casing of the processing unit comprises a display unit of the at least one light signal and houses the light-emitting source.

6. A teaching device according to claim 1, wherein the flexible light-emitting strip comprises a light-emitting source such as several light-emitting diodes aligned along an extension axis of the light-emitting strip.

7. A teaching device according to claim 6 wherein, in the light-emitting source, two immediately contiguous light-emitting diodes constitute a pair of light-emitting diodes, each pair of light-emitting diodes of the light-emitting strip being configured to visually guide to an unique note to be played when said light-emitting strip is associated to a keyboard of the electronic piano.

8. A teaching set for electronic piano, the teaching set comprising:
the teaching device according to claim 1, designed to be connected to an electronic piano by a connection system;
the electronic piano;
a MIDI/USB interface configured to establish a two-way communication between the electronic piano and the processing unit;
a remote peripheral terminal connected to the teaching device by a two-way wireless communication, the remote peripheral terminal comprising a monitoring display designed to monitor the teaching device.

9. A set according to the claim 8, wherein each key of the keyboard is associated with one of the pairs of light-emitting diodes of the light-emitting strip.

10. A teaching process for electronic piano implementing the teaching set according to claim 9, the process comprising the following steps:
a monitoring step of the teaching device by the remote peripheral terminal;
a configuration step of the teaching device thanks to the remote peripheral terminal;
a digital data transmission step from the remote peripheral terminal to the teaching device;
a visual guiding step, wherein the digital data transmitted by the remote peripheral terminal is converted into light at the light-emitting strip at the visual guiding step.
